(19) United States
(12) Patent Application Publication
(10) Pub. No.: US 2018/0013783 A1
(43) Pub. Date: Jan. 11, 2018

(54) METHOD OF PROTECTING A COMMUNICATION NETWORK

(71) Applicant: CyGlass Inc., Littleton, MA (US)

(72) Inventor: Rajini B. Anachi, Bolton, MA (US)

(73) Assignee: CyGlass Inc., Littleton, MA (US)

(21) Appl. No.: 15/634,346

(22) Filed: Jun. 27, 2017

Related U.S. Application Data
(60) Provisional application No. 62/359,447, filed on Jul. 7, 2016.

(51) Int. Cl. H04L 29/06; H04W 12/08; H04W 84/18

(52) U.S. Cl. CPC H04L 63/1433; H04W 12/08; H04W 84/18

(57) ABSTRACT

A method of determining a quantitative measure of the danger (a Trust/Risk) that a select network entity poses to the security and integrity of a communications network, the method includes setting a plurality of parameters. The parameters define the degree to which various behaviors within the communications network are considered usual or anomalous. Actual behavior of the select network entity is observed by watching network traffic using network packet-collection, recording packet properties, and using the packet properties to associate a select packet with the select network entity. Self-report messages broadcast by the select network entity are also observed. The Trust/Risk of the select network entity is then determined based on a comparison of the actual behavior to the self-report message and a comparison of the actual behavior to the plurality of parameters.

### CROSS REFERENCE TO RELATED APPLICATIONS

This application claims priority to and the benefit of U.S. Provisional Patent Application No. 62/359,447, filed on Jul. 7, 2016 and titled “TRUST/RISK FRAMEWORK”, the contents of which are incorporated herein by reference as though fully set forth herein.

### FIELD OF THE INVENTION

The subject disclosure relates to operating a communication network, and more particularly to identifying anomalous or dangerous activity in a communications network and taking remedial action.

### BACKGROUND OF THE INVENTION

Perhaps the most familiar example of a communication network is the Internet, along with the enterprise-scale organizational networks and the off-premises network-based Cloud services that are joined to the Internet using common standards and protocols, but there are many network technologies distinct from the Internet, including home and office Local Area Networks, mobile phone and radio networks, wired and wireless sensor networks, Industrial Control Systems, and the rapidly emerging area called the Internet of Things. Historically, these network technologies evolved independently to meet the needs of particular industries and market segments; the hardware, protocols, and standards that apply to Industrial Control Systems do not work in a Wireless Sensor Network and will not talk to a smart phone or tablet. Each network technology also has its own security and reliability concerns, its own set of plausible threats, vulnerabilities, and failure modes. This state of affairs made sense when each kind of network was a separate operation, but that is no longer the case. Today we expect to talk with our home thermostat from our smart phone, possibly using the coffee shop's WiFi hotspot to access the Internet to phone home. Phones talk to cars and cash registers, which talk to banks and in-store inventory systems. Connectivity between kinds of networks that were formerly separate is now the rule.

This richer interconnection exposes networks to new threats, new modes of attack, and new modes of cascading failure. As networks become more complex and heterogeneous, it is unrealistic to expect either human experts or automated systems to know all the relevant technologies in detail. Rather than trying to identify all the possible signs of attack in all possible combinations of network standards and protocols, we propose an approach to network defense that begins with evaluating the degree of Trust/Risk to be placed in network elements, and using quantitative Trust/Risk values to identify anomalous behavior, attack patterns, and malfunctioning elements, and to cause remedial actions.

### SUMMARY OF THE INVENTION

In light of the needs described above, in at least one aspect, the subject technology relates to a method for protecting a communications network. Behaviors of the network entities are observed and those observations are used to calculate a dynamically varying quantitative measure of the danger that a particular network entity poses to the integrity and security of the network under observation (Trust/Risk). Trust/Risk values are then used to identify anomalous behavior, attack patterns and malfunctioning elements and to cause remedial actions.

In one embodiment, the subject technology relates to a method of determining a quantitative measure of the danger (a Trust/Risk) that a select network entity poses to the security and integrity of a communications network. An actual behavior of the select network entity is observed by watching network traffic using network packet-collection, recording packet properties, and using the packet properties to associate a select packet with the select network entity. A self-report message broadcast by the select network entity is also observed. A plurality of parameters defining the degree to which various behaviors within the communications network are considered usual or anomalous are set. A determination is then made as to the Trust/Risk of the select network entity based on a comparison of the actual behavior to the self-report message and a comparison of the actual behavior to the plurality of parameters. In some embodiments, actual behaviors of a plurality of other network entities are observed. The plurality of network entities also broadcast reports of the actual behaviors of others of the network entities. Therefore Trust/Risk of the select network entity is further based on the reports of the actual behaviors of the plurality of network entities. In some embodiments, with respect to each actual behavior observed, an observance time represents the time at which the actual behavior was observed. A Dynamic Forgetting Algorithm is then applied to the Trust/Risk calculation of the select network entity to discount actual behaviors when the respective observance time is further in the past. To avoid exploitation, the Dynamic Forgetting Algorithm can be designed to account for anomalous actual behaviors which consistently repeat. In some cases, importance levels can be assigned to each of the plurality of network entities, the importance level quantitatively characterizing the importance of that respective network entity to the security and integrity of the communications network. The Trust/Risk of each network entity can then be determined based on a comparison of the actual behavior to the self-report message of that respective entity, a comparison of the actual behavior of the respective network entity to the plurality of parameters, and the importance level of the respective network entity.

In some embodiments, a Trust/Risk value can be determined for a target entity based on a comparison of actual behavior of the target entity to a self-report message of the target entity and a comparison of the actual behaviors of the target entity to the plurality of parameters. A machine readable Thereat Graph can also be constructed, the Threat Graph providing a quantitative representation of the danger posed by the select entity on the target entity known as a Threat Value. Trust/Risk values for the select entity and the target entity can then be further based on Threat Value. In some embodiments, a processing module can apply condition-action logic to determine an action to take based on the Trust/Risk of the select network entity to avoid harm to the communications network.

In some cases, at least one role identifier can be associated with the select network entity. The Trust/Risk of the select network entity is further based on whether the actual behavior of the select entity is an expected behavior based on the at least one role identifier. Trust/Risk determination then further includes evaluating effectiveness of previously determined levels of Trust/Risk and past methods of determining the previously determined levels of Trust/Risk. In at least one embodiment, the select network entity is a first sensor, measuring an observable feature (i.e. a temperature). Further, one of the other network entities is a second sensor that measures the same observable feature (temperature) as the first sensor.

In some embodiments, the subject technology relates to a system for safely running a network. The system has a processor coupled to a network interface and memory containing computer-readable code such that when the computer-readable code is executed by the processor, the processor performs a number of operations. The processor observes a plurality of behaviors, each behavior associated with a network entity. Observing the behaviors includes receiving a plurality of packets from the network interface, assigning each of the plurality of packets to one of the network entities based on identifying information in the packet, and recording information about the packet in a data structure indexed for each network entity. A plurality of self-reports are identified corresponding to each network entity from the plurality of network packets. A Trust/Risk value is determined for each of the network entities based on a divergence between the behavior associated with that network entity and the self-report from the respective network entity. A results report is generated based on a degree of anomaly of at least one of the network entities, the degree of anomaly calculated by comparing the Trust/Risk of the respective network entities to predefined statistical parameters to evaluate the degree to which said entities' behavior is usual or anomalous. The degree of anomaly is then used to determine whether a warning should be issued. The Trust/Risk value of each network entity is then recorded in persistent storage.

In some embodiments, the behaviors of neighbor network entities are observed by other network entities. The network entities report neighbor reports related to the behavior of the neighbor network entities. The Trust/Risk of each network entity is determined based further on a comparison between the behavior of the network entity, the self-reports of the network entity, and the neighbor reports. In some embodiments a machine readable Threat Graph is constructed which provides a Threat Value. The Threat Value is a quantitative representation of the danger posed by an attacking entity on a target entity, the attacking entity and target entity being part of the plurality of network entities. The Trust/Risk determination for each of the plurality of network entities is then further based on Threat Value of that respective network entity. In some embodiments, condition-action logic is applied, by a processing module, to determine an action to take based on the Trust/Risk of the each of the network entities to avoid harm to the network.

In some embodiments of the subject technology, a network is composed of sensor motes (nodes) with wireless connectivity to neighboring nodes, and a software module is implemented on each node that observes the behavior of neighboring nodes. From time to time each module broadcasts a packet containing the node's self-report of its own reliability, along with its report of the reliability of its neighbors. As each module receives these reports from its neighbors, it uses the reported values to calculate its own evaluation of the Trust/Risk to be assigned to each node for which it has information (i.e. itself, its neighbors, its neighbors' neighbors, and so forth).

In other embodiments of the subject technology, a network is composed of sensors as before, and the software modules monitor the numeric data stream that each of its neighbors transmits, as well as each neighbor's reliability report, in calculating Trust/Risk for that neighbor. Trust/Risk in this case is a vector with one value indicating the Trust that the node is a “good network citizen”, and a second value indicating the Trust that the node is sensing data correctly.

In still other embodiments, the network is a conventional office-scale IP-based network connected to the Internet, with wired and wireless internal connectivity. The network is composed of desktop workstations as well as more powerful centralized servers and networking infrastructure such as routers, gateways, and firewalls. Software Trust/Risk modules are implemented hierarchically in this environment. At the workstation level, each module periodically or occasionally broadcasts a packet containing the system's self-report of its own reliability, along with its report of the reliability of its neighbors. During times when the workstation is idle it will observe network activity by its neighbors, and it will used range-based detection to form an estimate of each observed neighbor's reliability. At the server level, more computing resources are available than at the workstation level, and one or more instances of a dedicated software module will be implemented for the purpose of performing consistency-based detection and environmental observation detection. Each such module will take in the broadcast self-report packets from workstations. The modules will also implement a poll-response messaging protocol to request and obtain report packets from workstations that cannot broadcast to the server. The purpose of these modules is to gather and consolidate Trust/Risk observations from many observer entities, and to use those observations to perform consistency-based detection and environmental observation detection as described above.

In still other embodiments, the network is geographically dispersed, combining numerous office-scale networks as described above into what is called an Enterprise network. Enterprise networks are characterized by significant levels of organizational separation into functional enclaves. For instance, a national retail company may have hundreds or thousands of branch stores, each store housing a network serving different departments—for example, customer and sales information , physical plant operations, inventory control and ordering, accounts, human resources and payroll—and the stores will have network connections to regional and national data centers. Government networks, including defense-related networks, are similarly organized. In networks of this size and complexity, workstation-based software modules will perform range-based detection and server-based modules will perform consistency-based and environmental detection at the department level as in the office-scale embodiment described above, and in addition, concentrator modules will be implemented at the regional- and national-level data centers. These high-level concentrators will receive summarized trust data from the office- or store-level data centers. The concentrator modules will maintain historical data and will analyze that data to perform additional consistency-based and environmental detection.

In still other embodiments, the network is similar to the office-scale or Enterprise networks described above, and in addition, it employs a number of Cloud-based services and capabilities. The Cloud refers to any or all of a suite of computing resources and data storage capabilities that are made available to users over the Internet by third-party providers, rather than being hosted on the customers' premises. Examples of Cloud services include, but are not limited to, Amazon Web Services, Microsoft Azure, and Google Docs and Google Drive. In these networks, one embodiment of the subject technology will reside in a Cloud instance and will be made available as a service to customers of the Cloud instance. For instance, an embodiment of the subject technology may reside in the Amazon Cloud and be made available to Amazon Web Services.

### BRIEF DESCRIPTION OF THE DRAWINGS

So that those having ordinary skill in the art to which the disclosed system pertains will more readily understand how to make and use the same, reference may be had to the following drawings.

FIG. 1 is a block diagram illustrating various data collection and processing techniques of the subject technology, as well as a communications network containing network domains within which the subject technology can be applied.

FIG. 2 is a flowchart depicting the flow of processing in some embodiments of the subject technology, particularly as is carried out in the domain atomic analytics module of FIG. 1.

FIG. 3 is a flowchart depicting the flow of processing in some embodiments of the subject technology, particularly as is carried out in the group analytics module of FIG. 1.

FIG. 4 is a flowchart depicting the flow of processing in some embodiments of the subject technology, particularly as is carried out in a data concentrator system of FIG. 1.

FIG. 5 is a flowchart showing a detailed expansion of the flow of processing of the Environmental Test of FIG. 4.

FIG. 6 is flowchart depicting one exemplary embodiment of steps of a method in accordance with the subject technology.

### DETAILED DESCRIPTION

The subject technology overcomes many of the prior art problems associated with operating a communications network. In brief summary, the subject technology provides a system and method where anomalous or dangerous activity is identified within a communications network and appropriate remedial action can be taken. The advantages, and other features of the systems and methods disclosed herein, will become more readily apparent to those having ordinary skill in the art from the following detailed description of certain preferred embodiments taken in conjunction with the drawings which set forth representative embodiments of the subject technology. Like reference numerals are used herein to denote like parts.

As used herein, certain terms and phrases of art are defined as follows:

“Trust” is a dynamic (time-varying) quantitative measure (a number or an ordered set of numbers) of how reliably we expect a network entity (such as a user, workstation, server, device, or service) to behave based on prior behaviors.

“Threat” represents information inherent in the network that measures the damage that could be done if a particular network entity (such as a node or set of nodes) is attacked. It is a predicted property.

“Risk” is a measure that is computed based on the predicted value of threat and the dynamic value of trust.

“Behavioral Trust Measure” (or “BTM”) is a measure of the assurance that an entity in the network will “play fair”, i.e. will follow the rules and cooperate rather than taking advantage of network resources for its own self-interest. Risk and Resilience Metric (“RRM”) is a value that varies inversely with Trust; it is a measure of the likelihood that an entity has become a bad network citizen, likely to do some sort of harm to the functioning of the network. The combination of the two measures is called BTM/RRM, or more descriptively, “Trust/Risk.”

“Trust/Risk” is a quantitative measure of the danger that a particular network entity poses to the integrity and security of the network under observation. The Trust/Risk model that we have developed has three essential components: mathematical properties, multi-dimensional Trust/Risk metrics, and behavior detection.

Mathematical Properties of Trust/Risk. Trust/Risk is established based on observed behaviors of an entity. In order to quantitatively evaluate Trust/Risk we identify mathematical properties of Trust/Risk values. Direct Trust/Risk is established when the behavior of entity A is directly observed. For instance, if a router self-reports that it has forwarded ten thousand packets to a particular subnet in the past thirty minutes, but a packet sniffer on that subnet only sees five thousand packets, then trust in the server is reduced and its risk score is raised. Similarly, but in a different network environment, if sensor A self-reports to a local programmable logic controller (PLC) that it has detected a power fluctuation at a particular time, but other sensors reporting to the same PLC contradict this report, then the true alarm Trust/Risk of sensor A will be reduced.

Trust/Risk is a dynamic characteristic. A good entity may be compromised and turned into a malicious one, while an incompetent entity may become competent due to environmental changes. In order to track these dynamics, an observation made a long time ago should not carry the same weight as one made recently. We have developed a dynamic forgetting scheme (or “Dynamic Forgetting Algorithm”) that allows an entity's Trust/Risk value to be redeemed with time and with subsequent good behaviors. The dynamic forgetting scheme allows for a single bad behavior to be forgotten more quickly than multiple bad behaviors. We have further developed a value called predictability Trust/Risk, which allows us to take into account a smart attacker who might try to take advantage of the dynamic forgetting scheme by behaving well and badly in an alternating pattern. We apply all of these mathematical properties to our Trust/Risk computation.

Multi-dimensional Trust/Risk Metrics. Trust/Risk can be multi-dimensional. That is, it can be determined by more than one behavior that the entity performs, and therefore, it may require aggregation of several types of Trust/Risk value. For example, in a Smart Grid electrical system, a sensor node, like a phasor measurement unit (“PMU”), is designed to detect and report on fluctuations in the power that is being transmitted. Thus, we could compute the following types of Trust/Risk based on the behaviors of these sensor nodes: detection Trust/Risk represents how much we trust a sensor to detect and report a power fluctuation; false alarm Trust/Risk represents how much we trust a sensor to report only when a power fluctuation is detected (no false alarms); availability Trust/Risk represents how much we trust a sensor to respond to a request for a report; and overall Trust/Risk is computed as an aggregate of all of the above Trust/Risk values. Overall Trust/Risk can be used to make decisions about how to self-heal a network, and it can be used by a human operator or by a software decision function to choose remedial actions.

Behavior Detection. In order for Trust/Risk to be utilized, the behaviors of the entities in the system must be monitored and bad behaviors must be detected. It is important to note here that in most detection scenarios, it is difficult to distinguish between a malicious behavior and an error in the system when examining each behavior in isolation. The subject technology will consider patterns of behavior as well as behavior of groups of network entities to make ultimate determinations of maliciousness. We define three levels of behavior detection. These three levels are used in conjunction with each other to provide a basis for computation of Trust/Risk for an entity.

The first level of behavior detection is known as range-based detection. This assumes that a range of expected values is known for a given entity. If the entity self-reports values that are well outside the expected range, this may be considered an indication of a bad behavior. For instance, a public-facing Web Server that self-reports receiving only a few dozen requests per hour is likely to be either compromised or malfunctioning, and a small business's email server should not be sending many thousands of emails per day. Similarly, in a Smart Grid system, if a sensor near a transmission substation is expected to report voltage values within a certain range, but at some point self-reports a very high voltage, outside of the expected range, this is considered a bad behavior.

The second level of detection is known as consistency-based detection, and it relies on the fact that network observations tend to provide redundant information. A simple example is found in sensor networks, using the values of multiple sensors (e.g. multiple temperature readings) to determine if there is some inconsistency in the self-reports. When the self-reports of sensors that are in close proximity, or sensors that are reporting on the same events, are inconsistent with each other, there is a good chance that some of those sensors are malicious. From this information alone, it may be difficult to determine which of the sensors is correct, but this type of detection can be used along with the other types to help identify the malicious behavior.

The third type of behavior detection is known as environmental observation detection. Here an appropriate example can be found in a heterogeneous network containing Smart Grid sensors and intelligent network devices; if a sensor indicates that power has been cut from a section of the grid, but there are devices in that section that continue to report normal operation, this is an indication that the sensor is reporting incorrectly.

A “communication network” is an assemblage of computers and their peripherals, electronic switching and routing devices, physical data channels, sensors and actuators, mobile devices with computing capability, and users, as well as one or more sets of protocols and procedures, in which information is communicated between and among devices and users in the form of packets transmitted on physical data channels.

An “information resource” is an object such as a sensor, file, directory, database, or processing service that can provide useful information to another user, device, or service using the network.

A “network entity” (or “network element”) is any component of a communication network that has a persistent identity; examples include, but are not limited to, users, workstations, servers, routers, firewalls, files, databases and data stores, software such as Web, file, and database servers, applications and services, sensors and actuators, data channels, and network packets.

A “network asset” (or “asset”) is a network entity that has a semantic description associated with it, such as a user's name and/or job title, a router's manufacturer, model number, and location, or a server's type (e.g. Web, database, or file) and a description of its content. Assets may be represented in many ways, including but not limited to key-value data structures, relational database records, and labeled property graphs.

A “physical data channel” is a combination of a physical medium (including free space as a medium for electromagnetic radiation) and a method for transmitting and receiving an information signal on that medium; example physical data channels include but are not limited to Ethernet, 802.11.x, Bluetooth, microwave, satellite link, and other wireless methods, optical fiber, broadband cable, telephone circuits, and data buses that are typically used for high-speed short-range communication within a computer or between modules in a rack enclosure; less commonly, acoustic waves through water can serve as a physical data channel, and a USB thumb drive that is physically carried from one computer to another can be considered a physical data channel.

A “neighbor entity” is a network entity whose behavior can be observed by a data collector; this typically means that the data collector and its neighbor entities are connected to the same physical data channel.

A “communication protocol” (or “protocol”) is a set of standard message formats and procedures that are used to exchange information between network entities across a physical data channel. Protocols may define, among other things, the physical representation of an item of information (for instance as an electronic waveform), a method for detecting and correcting errors in transmission, a method for ensuring reliable delivery of information, a method for assigning names or addresses to network entities, or a method for encrypting and decrypting information; this list is non-exhaustive.

A “domain” (or “enclave”) is a network or a region of a network that shares a common set of communication protocols. In some embodiments of the subject technology the network owners or managers may choose to define additional features that distinguish or set boundaries on domains, e.g. they may define the domain of network entities in a particular department or entities having a particular set of network addresses, but every such restricted domain will satisfy the definition of “domain”, i.e. it will share a common set of protocols. Where it serves the interests of clarity, such restricted domains will be called “subdomains.”

A “role identifier” refers to characteristics that define the role of network entities within the communications system. For example, a certain network entity may be associated within the network of an organization with a role identifier that defines them as an employee or a customer. Likewise, role identifiers can be used to identify a network entity as an information block, a server, an application, a service, or an infrastructure device, as examples.

The subject disclosure relates generally to determining quantitative measures of danger that a select network entity poses to the integrity and security of the network under observation (Trust/Risk).

In the algorithms that implement the subject technology, Trust values are normalized to take values between 0 and 1 inclusive, with 1 representing absolute Trust and 0 representing absolute Mistrust, i.e. certainty that the entity in question will behave badly or incorrectly. Threat is a non-negative number whose range is arbitrarily bounded above. The chosen upper bound serves as a scaling factor to make the resulting Trust/Risk values useful for reporting and visualization.

In some embodiments of the subject technology, Threat values are assigned to each network entity to represent how important the entity is to the integrity and security of the network. In other embodiments, Threat is assigned to pairs of network entities to account for the possibility that attacks on an entity T from an entity S may be more damaging than attacks on T from a different entity R—for instance, the attacker S may have more access privilege than R, or it may be less trusted than R based on other observations. If Threat values are assigned to pairs of entities rather than to each entity separately, the structure that matches entity pairs to Threat values is called a threat graph. A threat graph may be represented in numerous ways, including but not limited to (1) a connectivity matrix in which the rows represent potential attackers S and columns represent potential targets T, and the matrix entries are numbers representing the Threat that S poses to T; (2) a directed property graph in which the edge between S and T is labeled with the value of the Threat that S poses to T.

The equation to calculate Trust/Risk in a network is provided here. For a single entity attack on entity S:

Trust/Risk(S)=(1 Trust(S))*Threat(S) (1)

For multiple entity attacks, Trust/Risk is computed in two steps. First we compute Trust/Risk of individual entities using Equation (1). Then we adjust the Trust/Risk values according to links in the threat graph. If entities S and T are connected on the threat graph, let W(S,T) denote the weight of the link between S and T We adjust the Trust/Risk calculation for the entities using Equation (2).

Trust/Risk(S)=Trust/Risk(S)+Trust/Risk(T)*W(S,T)*α

Trust/Risk(T)=Trust/Risk(T)+Trust/Risk(S)*W(S,T)*α (2)

α=Attack Severity Parameter determined by threat model

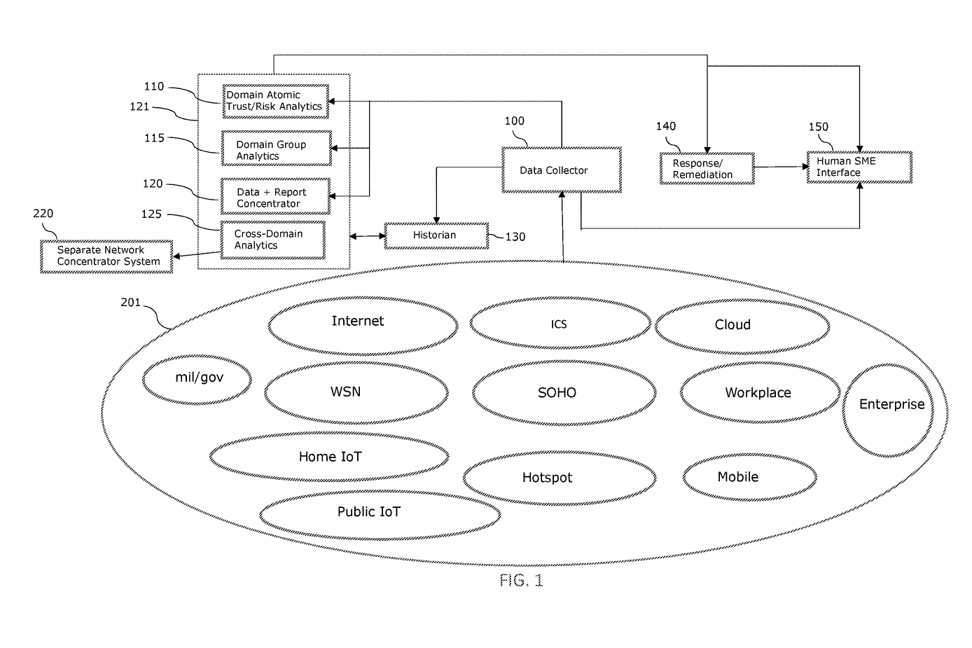

Referring to FIG. 1, an exemplary network architecture for monitoring and examining traffic and user and device behavior on communication networks, using those observations to assign a dynamically varying quantitative measure of behavioral Trust/Risk to network elements, and in turn using those Trust/Risk measures to identify anomalous behaviors, attack patterns, and malfunctioning elements, and to cause remedial actions, in accordance with some embodiments of the subject technology. The system consists of one or more data collector components 100, one or more domain-specific atomic Trust/Risk analytics modules 110 (or “atomic analytics modules”), one or more domain-specific group/aggregate Trust/Risk analytics modules 115 (or “group analytics modules”), one or more data and report concentrator systems 120 (or “concentrator systems”), one or more cross-domain analytics modules 125, a historian system 130, a response/remediation facility 140, an interactive human subject matter expert interface 150, and a communication network under observation 201 (a “NUO”). The NUO 201 may be homogeneous, i.e. composed of network elements that all communicate using a single suite of physical channel technologies and protocols, or heterogeneous, composed of network elements that communicate with one another using different physical channel technologies and/or different protocols.

The data collector 100 may be embodied in one or more dedicated stand-alone devices, or as a software component of a larger system, or as a combination of stand-alone devices and components. The data acquired by the collector includes, but is not limited to, full or partial network packets (headers and/or payloads) and flows from the NUO 201, full or partial content of application and system log files from elements in the NUO 201, full or partial directory information from domain controllers and authentication services in the NUO 201, expert-provided metadata about the configuration and organization of the NUO 201. In some cases in which the NUO 201 is heterogeneous, containing network enclaves that employ diverse technologies and protocol families, the data collector 100 is specialized for the purpose of ingesting network traffic and user and device behavior within a network enclave (a set of network elements sharing a common suite of channel technologies and protocols), converting some or all of the ingested data to a standardized format, and forwarding it to one or more concentrator systems 120.

The atomic Trust/Risk analytics module 110 may be embodied in one or more dedicated stand-alone devices, as a software component colocated with a data collector 100, as a software component of a larger system, or as a combination of stand-alone devices and components.

In some embodiments, the atomic analytics module 110 will receive streamed data from one or more data collectors 100 and will perform range-based behavior detection on each stream separately. Examples of data streams can be one of a number of observable features, a non-exhaustive list of such data streams including: sensor data readings such as temperature; pressure; electric voltage or current; frequency; velocity; acceleration; pH; light or sound intensity; properties of network packets and flows including but not limited to packet arrival times; flow times and durations; packet and flow sizes; source and destination addresses and ports; system events including but not limited to logon attempts, authentication successes and failures, CPU, memory, and disk utilization, and user account, file, and directory creation, modification, and deletion; and application-specific performance and behavior indicators such as transaction rates, response times, resource consumption, and partial or complete content of log files. The atomic analytics module 110 will perform range-based detection in one of two ways; first by comparing the value of each data item with predefined or learned threshold values for that item type, and second, by using a statistical or machine learning algorithm to detect values that remain within the thresholds, but whose statistical distribution has changed significantly. These “drift alerts” can indicate a gradually failing component or a stealthy under-the-radar attack. In embodiments of the atomic analytics module that are hosted on systems with sufficient storage and processing capability, Machine Learning methods may be used to learn the appropriate threshold values. The output of the atomic analytics module 110 is a numeric Range-based Detection Trust/Risk value representing the estimated likelihood that the network element being observed is trustworthy.

The group analytics module 115 may be embodied in one or more stand-alone devices as a software component colocated with one or more data collectors 100, as a software component of a larger system, or as a combination of stand-alone devices and components. In some embodiments, the domain group analytics module receives streamed data from one or more data collectors 100 such that the streamed data represents observations of the same feature from multiple sources, such as temperature readings from multiple thermal sensors. The group analytics module 115 will perform consistency-based detection as described previously, aggregating observations until a specified count or time limit is reached, then determining the statistical distribution of the set of observations and assigning a numeric Consistency-based Detection Trust/Risk score to each observed network entity based on the element's statistical closeness to the group's distribution.

The data and report concentrator system 120 may be embodied in one or more stand-alone devices, or as a software component of a larger system that may contain one or more data collectors 100, one or more atomic analytics modules 110, and/or one or more group analytics modules 115. In some embodiments the concentrator system receives streamed data from one or more data collectors 100 such that the streamed data represents observations of different features, parses the received streamed data into formatted records, and writes the records to persistent storage in such form that the data can be retrieved for subsequent processing. The persistent storage mechanism may include a large-scale distributed file system such as Hadoop HDFS, a NoSQL database such as HBase, Accumulo, or MongoDB, a graph database such as Neo4j, or a combination of these methods. The concentrator system 120 will perform environmental observation detection as described herein, comparing information about different observed network features to detect incompatible and possibly deceptive reporting. In some embodiments the system will apply predefined condition-action rules to identify incompatible feature reports. In other embodiments, machine learning methods will be used to discover natural dependencies between different features, and observations that violate those learned dependencies will be flagged as anomalies. In both cases the detected anomalies will be used to reduce the Trust score of the affected network entities.

The cross-domain analytics (“CDA”) module 125 may be embodied in one or more stand-alone devices, or as a software component of a larger system containing a combination of the previously described components. Recall that a domain is a network or a region of a network that shares a common set of communication protocols. For example, the network in a corporation's headquarters is a domain that shares the TCP/IP protocol suite and probably some form of Ethernet and wireless media-access protocols. If that corporation is a manufacturer, its headquarters network is likely to have some connections to an Industrial Control System (ICS) network that uses proprietary protocols, and that ICS network is a separate domain. In addition, the corporation's facilities management department is very likely to use an Internet-of-Things (IOT) network to monitor and control building operations, using intelligent thermostats, room activity sensors and lighting controls, card-access and RFID readers, and so forth; this IOT network is another separate domain. These multi-domain networks-of-networks pose unique and difficult security challenges, because legacy security tools are designed to protect single domains and very few security analysts are familiar with the protocols, operations, and potential vulnerabilities in more than one domain. The purpose of the CDA module 125 is to alleviate this problem by combining observations from the different domains that make up the network as a whole, and using the Trust/Risk abstraction as a common language for identifying misbehaving network entities in each domain. By viewing all the connected domains in the network together, the CDA module can discover patterns of attack that cross domain boundaries, and that would not be visible to methods that only look at a single domain.

In some embodiments the CDA module 125 is a processing element of a Big Data storage and processing framework employing parallel distributed processing, in-memory distributed processing, or a combination of those methods. In some embodiments, the CDA module 125 receives data representing a variety of different observable network features from one or more concentrator systems 220 located in separate network domains. Observable network features can include an output generated by the underlying network entity, for example, a temperature sensor can generate observable features in the form of temperature readings. In other embodiments, the CDA module 125 receives historical data from the historian system 130, described in more below.

The historian system 130 may be embodied in one or more stand-alone devices, or as a software component of a larger system containing a combination of the previously described components. In some embodiments of the subject technology, the historian system 130 will ingest some combination of observed data from one or more data collectors 100 and results of the collective analytics systems 121 (including atomic analytics modules 110, group analytics modules 115, concentrator systems 120, and/or cross-domain analytics modules 125). The historian system 130 will index the ingested data by time and Trust/Risk values for efficient retrieval. The purpose of the historian system 130 is to support consistency-based detection and environmental detection over extended periods of time, ranging from weeks to years.

The response/remediation system 140 may be embodied in one or more stand-alone devices, or as a software component of a larger system containing a combination of the previously described components. In some embodiments of the subject technology, the response/remediation system 140 will ingest alarm notification messages from one or more of the analytics systems 121, and will apply condition-action rules to select and perform automated remedial actions such as modifying firewall rules to block certain network traffic. In other embodiments, the response/remediation system 140 will ingest alarm data as above and will employ standard network protocols to direct network traffic away from malicious or misbehaving network entities.

A Human Subject Matter Expert (“SME”) Interface module 150 (or “SME module”) may be embodied as a software component of a system that also contains one or more atomic analytics modules 110, group analytics modules 115, concentrator systems 120, cross-domain analytics modules 125, and/or response/remediation systems 140. The SME module 150 defines and implements an Application Programming Interface (“API”), which is a standard set of message formats and message-exchange protocols. The API enables a human operator to query and set parameters used by the listed analytics modules, such as numeric limits and thresholds for range-based detection, aggregation counts or timers for consistency-based detection, and feedback to machine learning algorithms for environmental detection. Output generated by the SME module 150 generally comes from one or more of the data collector 100, the analytics systems 121, or the response/remediation system 140.

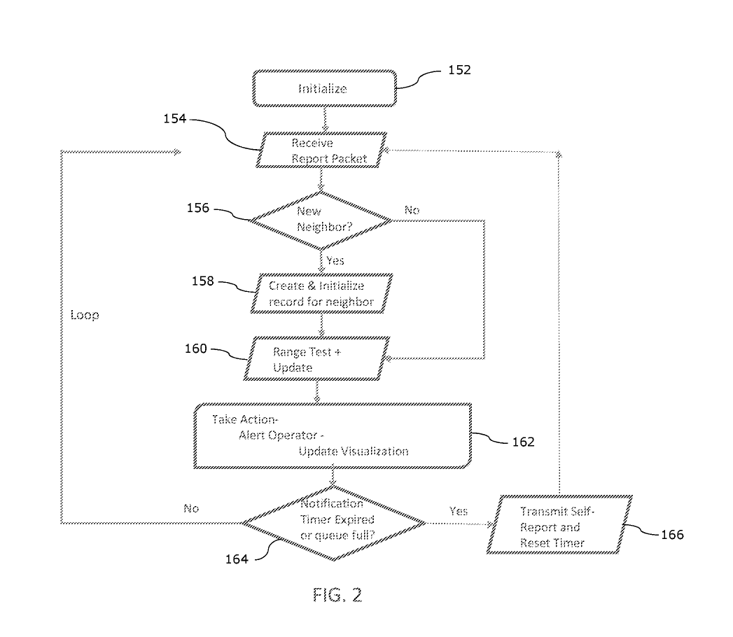

Referring now to FIG. 2, a flowchart showing the processing of the atomic analytics module 110 is shown. The processing can take place in a workstation or sensor mote (one homogeneous network domain “type”, e.g. sensor net, ICS, office network). In a typical embodiment, the associated analytics software resides inside a sensor mote or a workstation that is also host to a data collector module 100, called the local data collector. The local data collector makes direct observations of network traffic, and it also exchanges self-report messages with other data collectors in its domain, using network broadcast or multicast mechanisms. In other embodiments the atomic analytics module 110 does not have a local data collector, and instead receives self-report messages as well as network traffic observations from one or more remote data collectors. In either case, processing within the atomic analytics module 110 initializes at step 152. At step 154, the atomic analytics module 110 receives a report packet containing observational data of a neighbor entity's behavior or a neighbor entity's self-report. Because range-based detection is applied to properties of individual network entities, an embodiment must maintain separate tracking records for each neighbor entity it becomes aware of. Therefore at step 156, the atomic analytics module 110 determines if the network entity responsible for the packet is a new neighbor. If the network entity is not a new neighbor, the process proceeds to step 160 directly. Otherwise, a new tracking record is created for the new neighbor at step 158 before proceeding to step 160. In some embodiments the tracking records will record statistical properties of the entity's behavior, such as the volume or frequency of network traffic transmitted by the entity, or the range of temperatures reported by a sensor. In other embodiments the tracking records may record more detailed historical information about the entity's behavior.

After a tracking record for the network entity has been created or retrieved, one or more range-based detection algorithms are applied to the new observed data at step 160. As described earlier, the algorithms may compare the value of each data item with predefined or learned threshold values for that item type, or they may use a statistical algorithm based on Chebyshev's Inequality to detect values that remain within the thresholds, but whose statistical distribution has changed significantly. In some embodiments of the atomic analytics modules 110 that are hosted on systems with sufficient storage and processing capability, Machine Learning methods may be used to learn the appropriate threshold values. The output is a numeric Range-based Detection Trust/Risk value representing the estimated likelihood that the network entity being observed is trustworthy. At step 162, action is taken if the Trust/Risk value indicates that the entity has become a significant danger to the network's security or integrity. For example, tangible output, such as a warning or alarm, can be generated at step 162 to warn a user. In some circumstances, the action taken is to notify an operator by various means, such as sending email or a text message or updating a visual display element. In other cases the action taken may be an automated response action, such as quarantining the offending entity using firewall rules.

After each processing cycle, the atomic analytics module 110 performs a check to determine whether it is time to send one or more report packets to neighbor entities. The report packet contains the atomic analytics module's 110 self-report of its own behavior since the previous report, including data such as size and number of packets sent and received. It also contains a summary of the observations of neighbor entities that the atomic analytics module 110 has received and processed, and the atomic analytics module's 110 Trust/Risk scores for those neighbor entities. Report packets will be transmitted either periodically on expiration of a timer, or when available space for queueing/buffering of report data is exhausted. Therefore at step 164, the atomic analytics module 110 checks whether the timer has expired, or whether space is available space has been exhausted, as the case may be. If the timer has not expired and/or space has not be exhausted, the atomic analytics module loops back to step 154 to receive a new report packet. If the timer has expired, or available space has been exhausted, then at step 166 the atomics analytics module transmits the report packet and resets the timer before looping back to step 154 to receive or wait to receive the next report packet.

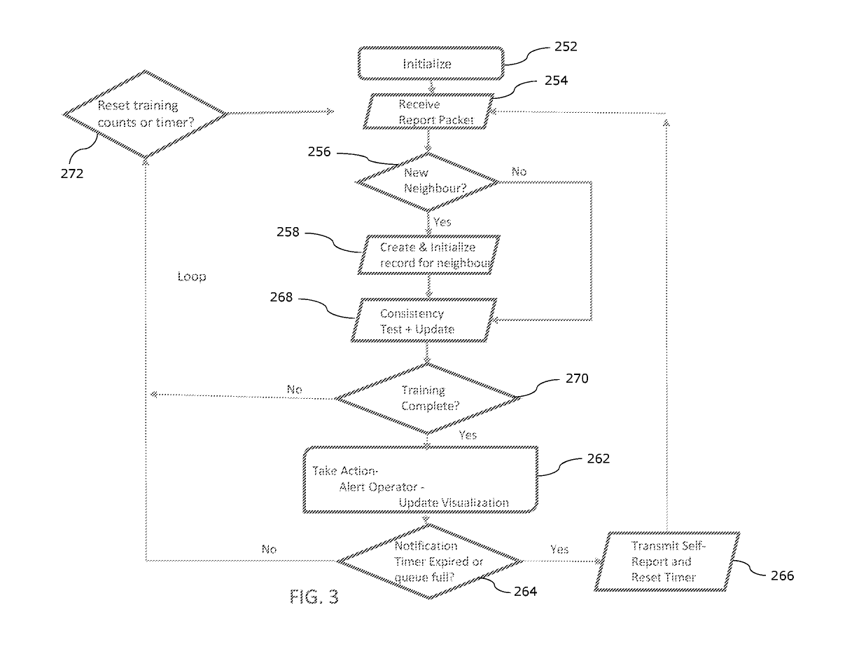

Referring now to FIG. 3, the flow of processing in a group analytics module 115 is shown. In general, the group analytics module 115, receives observation reports of a single observable feature from multiple sources, such as temperature readings from multiple thermal sensors. Preliminary steps of this processing (i.e. steps 252-258) are similar to those of FIG. 2 which have like reference numerals (i.e. steps 152-158) and the description therefore will not be repeated. The received packets contain streamed data from one or more data collectors 100 such that the streamed data represents observations of the same feature from multiple sources, such as temperature readings from multiple thermal sensors in the same general location. At step 268 a consistency test and update is performed where observations of each entity are aggregated until a specified count or time limit is reached. The statistical distribution of the set of observations is then calculated and each observed network entity is assigned a numeric Consistency-based Detection Trust/Risk score based on the element's statistical closeness to the group's distribution. The group analytics module 115 does not begin reporting until it has collected enough samples of a given feature to yield an accurate statistical characterization of the range and distribution of the feature's values. The period before which a sufficient number of samples has been collected can be referred to as the “training period.” Therefore, at step 270, if the count or time limit has not been reached, the method loops back to step 254 to wait for or receive additional packets and the training period continues. On the other hand, if the count or time limit has been reached, the training period is complete and action is taken at step 262.

Immediately after step 270, the steps performed by the group analytics module 115 (i.e. steps 262-266) are similar to those of the atomic analytics module 110 of FIG. 2 which have like reference numerals (i.e. steps 162-166) and therefore the description of those steps will not be repeated herein. In some embodiments of the subject technology, a group analytics module 115 may restart its analysis of one or more features by clearing its existing records for those features and resetting its training counts or timer values at step 272. This retraining can be of value when entities are added to or removed from the original reporting set, or when the environment changes and the original distribution of feature values no longer applies (e.g. to account for seasonal changes in outdoor temperature).

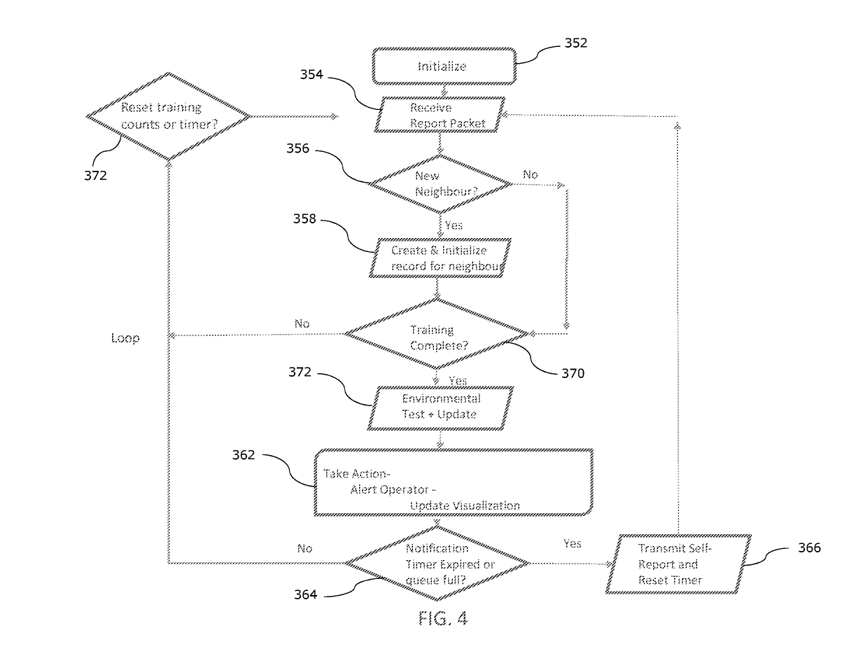

Referring now to FIG. 4, the flow of processing in a concentrator system 120 (or concentrator module) is shown. In general, the concentrator system 120 receives observations of one or more features from one or more reporter systems in a single network domain. In some embodiments, the report systems have access to Big Data resources and historical data. In the concentrator system 120, the received data and report packets represent observations of different features of network entities from one or more data collectors. Many of the steps of the concentrator system 120 (i.e. steps 352-372) are the same as the steps of group analytics module 115 bearing like reference numerals (i.e. steps 252-272) and so no further description is contained herein. The differences between the processing of the concentrator system 120 and group analytics module 115 are discussed in more detail below.

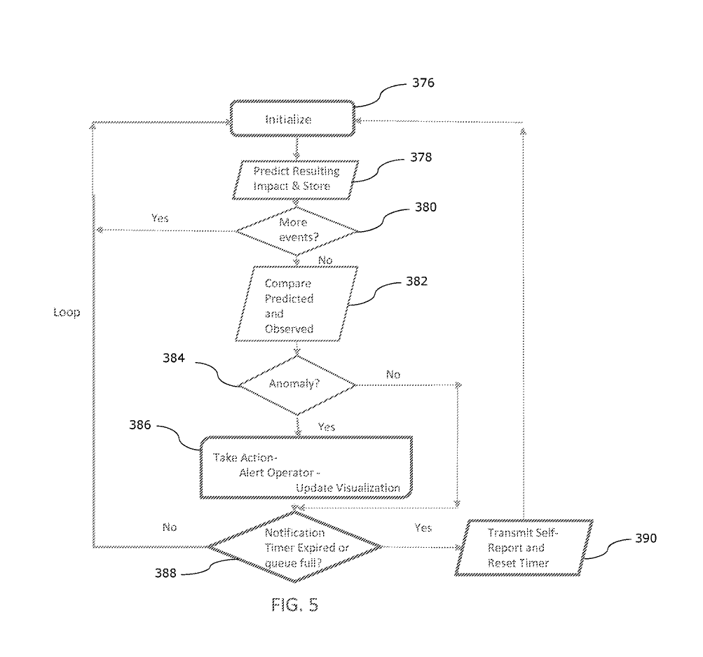

The concentrator system 120 differs in that there is no consistency tests step 268 performed during the training loop. Instead, the training period loop of steps 354, 358, and 370 is completed before an environmental test and update is performed at step 374 (described in more detail in FIG. 5). Environmental detection operates on the results of previous stages of analytics, not on raw data values. Therefore, determining completion of the training period loop at step 370 differs from completion of the training period loop 270 described with respect to the group analytics module 115. While completion of the group analytics module 115 requires a quantity of samples to be statistically significant, the training period loop of the concentrator system 120 is complete at step 370 when enough different kinds of samples are obtained to enable the environmental detection algorithms to create meaningful results. The specific requirements for completion of training period loops vary; in different embodiments different requirements for completion of the training period loop are used depending on the particular methods and algorithms they implement.

Referring now to FIG. 5, the process of performing an environmental test and update (step 374 of FIG. 4) is shown in greater detail. The process begins at step 376, after the concentrator system 120 has completed the training period loop. Results for a particular network entity are then predicated and stored at step 378. For example, if a sensor indicates that power has been cut from a section of the grid, but there are devices in that section that continue to report normal operation, this is an indication that the sensor is reporting incorrectly. At step 380, a determination is made as to whether results for other entities within the network need to be predicted and stored. If so, the process loops pay to step 376. Once the full number of resulting impacts have been predicted and stored, the process moves to step 382. At step 382, predicted and observed behavior of a network entity are compared. This can be accomplished in numerous ways. In some embodiments the system will apply predefined condition-action rules to identify incompatible feature reports. In other embodiments, machine learning methods will be used to discover natural dependencies between different features, and observations that violate those learned dependencies will be flagged as anomalies. In any case, at step 384, a determination is made as to whether the network entity's behavior should be considered anomalous. If anomalous behavior is found, action can be taken at step 386, such as reporting a warning or alerting a network moderator by an alarm. Further, detected anomalies will be used to reduce the Trust score of the affected network entities. The aforementioned steps can be repeated on a timer, or until a set queue is full. Therefore at step 388, if a timer is not satisfied and/or queue not filled, the process can loop back to step 376 and repeat. Otherwise, the timer can be reset at step 390, repeating only once the concentrator system 120 next requires an environmental test and update.

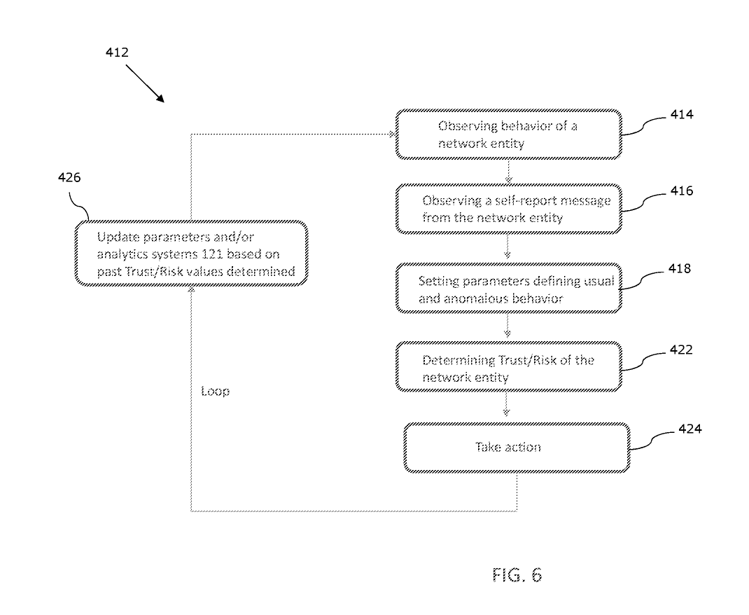

Referring now to FIG. 6, a method of protecting a network system by determining a quantitative measure of danger that a network entity poses to the security and integrity of a communications network is shown generally at 412. As discussed above, the quantitative measure of danger can be referred to as a Trust/Risk value. The process begins at step 414 by observing the behavior of a network entity within the network. This can be accomplished by watching network traffic using packet-collecting, recording packet properties, and finding one or more packets that are associated with the correct network entity, for example, by source and destination addresses. Next, at step 416, self-report messages which are broadcast by the select network entity are observed. In general, a data collector 100 can accomplish steps 414 and 416 by gleaning the relevant information from the network.

Next, at step 418, parameters are defined to determine which behaviors by the network entity will be considered usual and which behaviors will be considered anomalous. In different examples, these parameters can be set by a user, or automatically generated by the analytics systems 121 based on the past experiences and results. At step 422, the various analytics systems 121 generate a Trust/Risk value for the network entity based on applying analytics to the collected data as discussed herein. For example, the analytics systems 121 can compare the actual behavior of the network entity to the plurality of parameters such that the network entities behavior can be classified as usual or anomalous. Further, the analytics systems 121 can look for differences between the actual behavior of the network entity to the self-report messages of the network entity to help determine the Trust/Risk score for the network entity. In different embodiments, the analytics systems 121 can also apply other methods to further refine Trust/Risk score, such as comparing the network entity's behavior with the behavior of neighbors, applying a Dynamic Forgetting Algorithm to discount behaviors which occurred further in the past, and comparing the behavior of the network entity to behaviors of similar network identities based on shared role identifiers. Notably, these are only examples of criteria that can be used in determining Trust/Risk, and ultimately, one or more of the criteria discussed herein can be applied to Trust/Risk for a given network entity.

After Trust/Risk has been determined at step 422, action can then be taken based on the Trust/Risk value of the network entity at step 424. For example, if the network entity is determined to pose a high risk to the network, a network operator can be alerted by a report, e-mail, alarm, or the like. Additionally, or alternatively, if a network entity is determined to pose a great danger to the network than action can automatically be taken, for example, by prohibiting access of the network entity to the network.

Finally, the method loop can be repeated for other network entities. At step 426, as the method loops back to be repeated, the Trust/Risk score that was calculated can be stored or used to update parameters and/or algorithms within the analytics systems 121. Particularly, when actual danger of a network entity is realized, this can be compared with past calculated Trust/Risk scores to determine effectiveness of the Trust/Risk methods in place. For example, the update analytics systems 121, the set parameters, and/or other criteria for determining Trust/Risk can be updated based on the effectiveness of past methods of determining Trust/Risk.

It will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g., electronics, modules, networks, systems, alarms, sensors, and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A method of protecting a communications network by determining a quantitative measure of the danger (a Trust/Risk) that a select network entity poses to the security and integrity of the communications network, the method comprising:
observing an actual behavior of the select network entity by: watching network traffic using network packet-collection; recording packet properties; and using the packet properties to associate a select packet with the select network entity;
observing a self-report message broadcast by the select network entity;
setting a plurality of parameters defining the degree to which various behaviors within the communications network are considered usual or anomalous; and
determining the Trust/Risk of the select network entity based on: a comparison of the actual behavior to the self-report message; and a comparison of the actual behavior to the plurality of parameters.

2. The method of claim 1, further comprising:
observing a plurality of actual behaviors of a plurality of network entities; and
broadcasting, by the plurality of network entities, reports of the actual behaviors of others of the plurality of network entities,
wherein determining the Trust/Risk of the select network entity is further based on the reports of the actual behaviors of the plurality of network entities.

3. The method of claim 2 further comprising:
identifying, with respect to each actual behavior observed, an observance time representing the time at which the actual behavior was observed,
wherein determining the Trust/Risk of the select network entity further includes applying a Dynamic Forgetting Algorithm discounting actual behaviors based on respective observance times such that the actual behaviors are given less weight when their respective observance time are further in the past.

4. The method of claim 3 wherein the Dynamic Forgetting Algorithm is designed to avoid exploitation attempts by accounting for anomalous actual behaviors which consistently repeat.

5. The method of claim 4, further comprising:
assigning an importance level to each of the plurality of network entities, the importance level quantitatively characterizing the importance of that respective network entity to the security and integrity of the communications network; and
determining the Trust/Risk of the plurality of each of the network entities based on: a comparison of the actual behavior to the self-report message of that respective entity; a comparison of the actual behavior of the respective network entity to the plurality of parameters; and the importance level of the respective network entity.

6. The method of claim 5, further comprising:
determining a Trust/Risk value for a target entity based on: a comparison of actual behavior of the target entity to a self-report message of the target entity; and a comparison of the actual behaviors of the target entity to the plurality of parameters; and
constructing a Threat Graph, the Threat Graph being machine readable and providing a Threat Value, the Threat Value being a quantitative representation of the danger posed by the select entity on the target entity,
wherein determining the Trust/Risk values for the select entity and the target entity is further based on Threat Value.

7. The method of claim 6 further comprising:
applying condition-action logic, by a processing module, to determine an action to take based on the Trust/Risk of the select network entity to avoid harm to the communications network.

8. The method of claim 5 further comprising:
associating the select entity with at least one role identifier,
wherein determining the Trust/Risk of the select network entity is further based on whether the actual behavior of the select entity is an expected behavior based on the at least one role identifier.

9. The method of claim 8 wherein determining the Trust/Risk further comprises evaluating effectiveness of previously determined levels of Trust/Risk and past methods of determining the previously determined levels of Trust/Risk.

10. A method of protecting a communications network by determining a quantitative measure of the danger (a Trust/Risk) that a select network entity poses to the security and integrity of the communications network, the method comprising:
determining at least one role identifier associated with the select network entity;
setting a plurality of parameters defining the degree to which various behaviors within the communications network are considered usual or anomalous;
observing an actual behavior of the select network entity by: watching network traffic using network packet-collection; recording packet properties; and using the packet properties to associate a select packet with the select network entity;
identifying a plurality of similar network entities sharing, the plurality of similar network entities sharing at least one role identifier with the select network entity;
observing a neighbor behavior associated with each of the plurality of similar network entities by: watching network traffic using network packet-collection; recording packet properties; and using the packet properties to associate a neighbor packet with the similar network entity; and
determining the Trust/Risk of the select network entity based on: a comparison of the actual behavior of the select entity and the neighbor behavior of at least one of the plurality of similar network entities; and the plurality of parameters.

11. The method of claim 10 wherein:
the select network entity is a first sensor, measuring an observable feature; and
at least one of the plurality of similar network entities is a second sensor that measures the observable feature measured by the first sensor.

12. A system for safely running a network comprising:
a processor coupled to a network interface and memory containing computer-readable code, such that when the computer-readable code is executed by the processor, the processor performs the following operations:
observing a plurality of behaviors, each behavior associated with a network entity, wherein observing the behaviors includes: receiving a plurality of packets from the network interface; assigning each of the plurality of packets to one of the network entities based on identifying information in the packet; and recording information about the packet in a data structure indexed for each network entity;
identifying a plurality of self-reports corresponding to each network entity from the plurality of network packets;
determining a Trust/Risk value for each of the network entities based on a divergence between the behavior associated with the respective network entity and the self-report from the respective network entity;
generating a results report based on a degree of anomaly of at least one of the network entities, the degree of anomaly calculated by comparing the Trust/Risk of the respective network entities to predefined statistical parameters to evaluate the degree to which said entities' behavior is usual or anomalous;
using the degree of anomaly to determine whether a warning should be issued; and
recording the Trust/Risk value of each network entity in persistent storage.

13. The method of claim 12, further comprising:
observing, by the network entities, behaviors of neighbor network entities; and
reporting, by the plurality of network entities, neighbor reports related to the behavior of the neighbor network entities,
wherein determining the Trust/Risk of each network entity is further based on a comparison between the behavior of the network entity, the self-reports of the network entity, and the neighbor reports.

14. The method of claim 13 wherein the step of observing the plurality of behaviors further includes applying a Dynamic Forgetting Algorithm discounting the behaviors based on respective observance times, the behaviors given less weight when their respective observance times are further in the past.

15. The method of claim 14 wherein the Dynamic Forgetting Algorithm is designed to avoid exploitation attempts by accounting for anomalous behaviors which are consistently repeated by one of the network entities.

16. The method of claim 12 wherein:
at least one of the network entities is a first sensor, the first sensor measuring an observable feature;
at least one of the network entities is a second sensor that measures the observable feature measured by the first sensor; and
determining a Trust/Risk for the first sensor further includes comparing the behavior of the first sensor with behavior of the second sensor.

17. The method of claim 15, wherein:
an importance level is assigned to each of the plurality of network entities, the importance level quantitatively characterizing the importance of that respective network entity to the security and integrity of the network; and
determining the Trust/Risk of each network entity is further based on the importance level assigned to that respective network entity.

18. The method of claim 17, further comprising:
constructing a Threat Graph, the Threat Graph being machine readable and providing a Threat Value, the Threat Value being a quantitative representation of the danger posed by the an attacking entity on a target entity, the attacking entity and target entity being part of the plurality of network entities,
wherein determining the Trust/Risk for each of the plurality of network entities is further based on Threat Value of that respective network entity.

19. The method of claim 17 further comprising:
associating each of the network entities with at least one role identifier,
wherein determining the Trust/Risk of each of the network entities is further based on whether the behavior of the respective network entity is an expected behavior based on the at least one role identifier associated with the respective network entity.

20. The method of claim 17 further comprising:
applying condition-action logic, by a processing module, to determine an action to take based on the Trust/Risk of the each of the network entities to avoid harm to the network.
